(19) United States
(12) Patent Application Publication
(10) Pub. No.: US 2023/0276519 A1
(43) Pub. Date: Aug. 31, 2023

(54) METHOD, DEVICE AND COMPUTER READABLE MEDIUM OF COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/040,068

(22) PCT Filed: Aug. 6, 2020
(86) PCT No.: PCT/CN2020/107496

§ 371 Date: Jan. 31, 2023

(51) Int. Cl. H04W 76/19; H04W 24/08; H04L 5/00

(52) U.S. Cl. CPC H04W 76/19; H04W 24/08; H04L 5/0053

(57) ABSTRACT

Embodiments of the present disclosure provide methods, devices and computer readable media for communication. The method comprises determining, at a terminal device, link qualities of reference signals in first and second sets of reference signals received from a network device, the first set of reference signals being associated with a first control resource set and the second set of reference signals being associated with a second control resource set; and in accordance with a determination that a link quality of each reference signal in the first set is less than the first threshold quality, transmitting a signaling for link recovery to the network device, the signaling comprising a first indication about the first control resource set. The method further comprises receiving, at the network device, the signaling for link recovery; and performing a link recovery procedure for the first control resource set. In this way, BFR is carried out per TRP and a reduced latency and an improved efficiency are attained.

### TECHNICAL FIELD

Embodiments of the present disclosure generally relate to the field of telecommunication, and in particular, to methods, devices and computer readable media of communication for beam failure recovery (BFR).

### BACKGROUND

Due to increased free space path loss in higher frequency band supported in new radio access (NR), channel or signal transmission relies on highly directional links. Directional links, however, require fine alignment of the transmitter and receiver beams, achieved through a set of operations known as beam management. For example, the beam management may generally include operations like beam sweeping, beam measurement, beam determination and beam reporting. These operations can be periodically repeated to update the optimal transmitter and receiver beam pair over time.

A beam failure may occur when the quality of one or more beam pairs of an associated control channel falls low enough. A mechanism to recover from a beam failure may be triggered when the beam failure (also referred to as a link failure herein) occurs. The BFR mechanism on a terminal device side usually includes at least one of the following operations: beam failure detection (BFD), identification of a new candidate beam, transmission of a BFR request and monitoring a response for the BFR request from a network device. In NR, the network device may be equipped with multiple transmission and reception points (TRPs) or antenna panels. However, in current BFR mechanism, even if all BFR RSs for one TRP have already been failed, the BFR procedure may still not be triggered in some cases. This will cause an increased latency and a reduced network performance.

### SUMMARY

In general, example embodiments of the present disclosure provide method, device and computer readable medium of communication for BFR.

In a first aspect, there is provided a method of communication. The method comprises: determining, at a terminal device, link qualities of reference signals in first and second sets of reference signals for link failure detection received from a network device, the first set of reference signals being associated with a first control resource set and the second set of reference signals being associated with a second control resource set; and in accordance with a determination that a link quality of each reference signal in the first set is less than the first threshold quality, transmitting a signaling for link recovery to the network device, the signaling comprising a first indication about the first control resource set.

In a second aspect, there is provided a method of communication. The method comprises: receiving, at a network device and from a terminal device, a signaling for link recovery, the signaling comprising a first indication about a first control resource set associated with a first set of reference signals for link failure detection; and performing a link recovery procedure for the first control resource set.

In a third aspect, there is provided a terminal device. The terminal device comprises a processor and a memory coupled to the processor. The memory stores instructions that when executed by the processor, cause the terminal device to perform the method according to the first aspect of the present disclosure.

In a fourth aspect, there is provided a network device. The network device comprises a processor and a memory coupled to the processor. The memory stores instructions that when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example scenario of multi-TRP transmission according to some embodiments of the present disclosure;

FIG. 3 illustrates a schematic diagram illustrating a process for communication during BFR according to some embodiments of the present disclosure;

FIG. 4 illustrates a flowchart of an example method for BFR implemented at a terminal device in accordance with some embodiments of the present disclosure;

FIG. 5 illustrates a flowchart of another example method for BFR implemented at a terminal device in accordance with some embodiments of the present disclosure;

FIG. 6 illustrates a flowchart of an example method for BFR implemented at a network device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), a low power node such as a femto node, a pico node, and the like.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like.

As used herein, the term “TRP” refers to an antenna array (with one or more antenna elements) available to the network device located at a specific geographical location. For example, a network device may be coupled with multiple TRPs in different geographical locations to achieve better coverage.

In one embodiment, the terminal device may be connected with a first network device and a second network device. One of the first network device and the second network device may be a master node and the other one may be a secondary node. The first network device and the second network device may use different RATs. In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. The terms ‘BFR’, IRR′, ‘beam failure recovery’, ‘link recovery’, ‘BFRQ’, ‘beam failure recovery request’, ‘link recovery request’ may be used interchangeably. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In conventional BFR procedure, a terminal device may monitor BFD reference signals (RSs) to assess if a beam failure occurs. Once all the RSs failed, the terminal device may monitor beam identification RSs to find a new candidate beam. Once the candidate beam is identified, the terminal device may send a BFR signaling carrying information about the identified candidate beam to the network device. The terminal device may monitor a control channel search space to detect a response to the BFR signaling from a network device. Once the terminal device receives the beam recovery acknowledgement from the network device, the new beam pair can be considered to be established and the beam failure can be considered to be recovered.

However, in some cases, even if all BFD RSs for one TRP have already been failed, the BFR procedure may still not be triggered due to other well-connected BFD RSs for the other TRP. This will cause an increased latency and a reduced network performance.

In view of this, embodiments of the present disclosure provide a solution of BFR per TRP, also referred to as partial BFR based on multi-TRP. In the solution, if all BFD RSs for one TRP are failed, the BFR procedure will be triggered. In one aspect, embodiments of the present disclosure provide a procedure for BFR per TRP. In another aspect, embodiments of the present disclosure provide a solution of BFD RS configuration and candidate beam RS configuration for BFR per TRP. In still another aspect, embodiments of the present disclosure provide a solution of a combination of partial BFR and normal BFR procedures. In this way, BFR can be performed per TRP, and thus an increased latency is avoided and an improved network performance is provided. Principles and implementations of the present disclosure will be described in detail below with reference to the figures.

FIG. 1 illustrates an example communication network 100 in which embodiments of the present disclosure can be implemented. As shown in FIG. 1, the network 100 includes a network device 110, which is coupled with two TRPs/panels 120-1 and 120-2 (collectively referred to as TRPs 120 or individually referred to as TRP 120). The network 100 also includes a terminal device 130 served by the network device 110. It is to be understood that the number of network devices, terminal devices and TRPs as shown in FIG. 1 is only for the purpose of illustration without suggesting any limitations. The network 200 may include any suitable number of devices and TRPs adapted for implementing embodiments of the present disclosure.

As shown in FIG. 1, the network device 110 may communicate with the terminal device 130 via the TRPs 120-1 and 120-2. In the following text, the TRP 120-1 may be also referred to as the first TRP, while the TRP 120-2 may be also referred to as the second TRP. Each of the TRPs 120 may provide a plurality of beams for communication with the terminal device 130. For example, the TRP 120-1 may include four beams 121-1, 121-2, 121-3, and 121-4 (collectively referred to as “beams 121” or individually referred to as “beam 121”), while the TRP 120-2 may also include four beams 122-1, 122-2, 122-3 and 122-4 (collectively referred to as beams 122 or individually referred to as beam 122). It is to be understood that the number of beams as shown in FIG. 1 is only for the purpose of illustration without suggesting any limitations. The TRP 120 may provide any suitable number of beams adapted for implementing embodiments of the present disclosure.

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, a beam failure may occur if the network device 110 is no longer able to reach the terminal device 130 via a downlink control channel (such as, PDCCH) due to incorrect adjustment of the beams, blockage effect, movement of the terminal device, or some other reasons. For example, the terminal device 130 may detect this situation by estimating the quality of a hypothetical PDCCH reception transmitted over a beam (for example, a beam from the TRP 120-1 or 120-2) the network device 110 would use to reach the terminal device 130. To perform BFD, the terminal device 130 may estimate the quality of a hypothetical PDCCH reception based on reception of a certain reference signal (RS). In the following text, this reference signal may also be referred to as “BFD RS” or “RS for BFD”. Examples of the BFD RS may include but not limited to periodic channel state information-reference signal (CSI-RS), synchronization signal/physical broadcast channel block (SS/PBCH block), or a combination thereof.

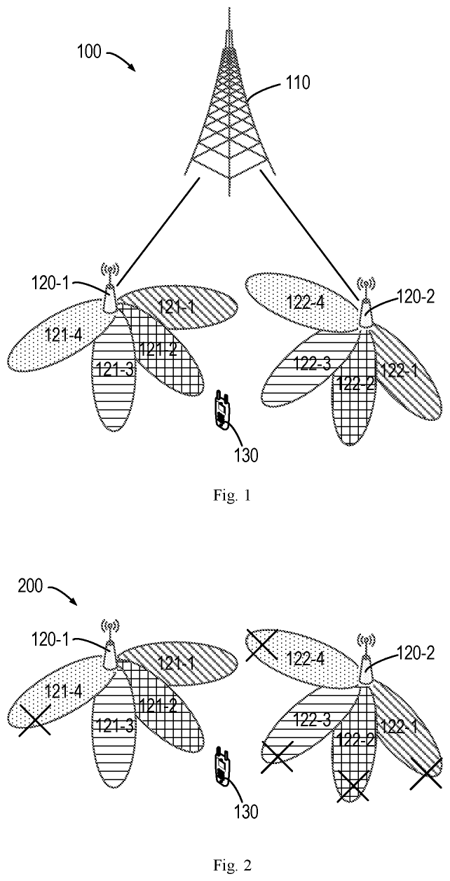

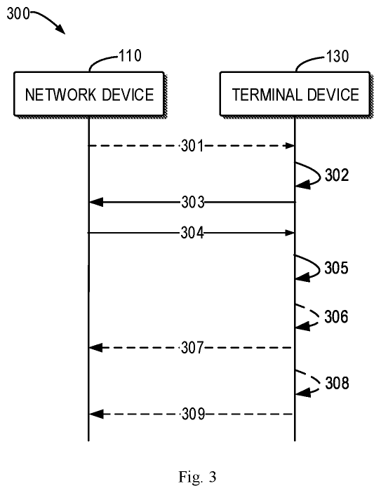

In some embodiments, when the quality of the hypothetical PDCCH reception for a beam is worse than a threshold, the terminal device 130 may determine that the beam failed. In some embodiments, the terminal device 130 may detect that all beams of one TRP failed but there are still other beam(s) of the other TRP well-connected. FIG. 2 illustrates an example scenario 200 of multi-TRP transmission according to some embodiments of the present disclosure. For convenience, it will be described in connection with the example of FIG. 1. As shown in FIG. 2, the terminal device 130 may detect that all beams 122 of the TRP 120-2 and beam 121-4 of the TRP 120-1 failed, but beams 121-1, 121-2 and 121-3 are still well connected. In this case, a BFR procedure is not triggered in conventional solution. However, according to embodiments of the present disclosure, the terminal device 130 will trigger a BFR procedure for the TRP 120-2. The BFR procedure per TRP will be described in more detail with reference to FIG. 3.

FIG. 3 illustrates a schematic diagram illustrating a process 300 for communication during BFR according to embodiments of the present disclosure. For the purpose of discussion, the process 300 will be described with reference to FIG. 1. The process 300 may involve the network device 110 and the terminal device 130 as illustrated in FIG. 1.

As shown in FIG. 3, the network device 110 may transmit 301 resource configuration information associated with BFR per TRP. In some embodiments, the network device 110 may transmit the resource configuration information via a RRC higher layer signaling. Of course, any other suitable ways are also feasible.

In some embodiments, the network device 110 may configure at least one control resource set (CORESET) to the terminal device 130. In some embodiments, the network device 110 may configure R CORESETs to the terminal device 130, and R is positive integer. For example, 1≤R≤5. For example, the R CORESETs may be configured for an active bandwidth part (BWP). For example, the R CORESETs may be configured for a cell. In some embodiments, each CORESET may be configured with a parameter such as CORESETPoolIndex. In some embodiments, at least one CORESET may be configured with a parameter such as CORESETPoolIndex. In some embodiments, there may be S CORESET(s) which is not configured with a parameter such as CORESETPoolIndex, and S is an integer. For example, 0≤S≤5. In some embodiments, the CORESETPoolIndex may have N different values, where 1≤N≤4. For example, N=2. In this case, the CORESETPoolIndex may have a value of 0 or 1. Of course, any other suitable values are also feasible.

In some embodiments, within the R CORESETS, there may be T CORESETs, and T is an integer. For example, 0≤T≤5. For the T CORESETs, the terminal device 130 may not be provided with CORESETPoolIndex or the terminal device 130 may be provided CORESETPoolIndex with a value of 0. For example, the T CORESETs may be assumed to be a first set of CORESETs (denoted as C1). For example, C1 is associated with TRP 120-1. For the R-T CORESETs, the terminal device 130 may be provided CORESETPoolIndex with a value of 1. For example, the R-T CORESETs may be assumed to be a second set of CORESETs (denoted as C2). For example, C2 is associated with TRP 120-2.

In some embodiments, the network device 110 may configure M sets of BFD RSs and/or L sets of candidate beam RSs to the terminal device 130. For example, M is an integer, and 0≤M≤N. For example, L is an integer, and 0≤L≤N. In some embodiments, L=M. In some embodiments, M≤L. Of course, the present application is not limited to this, and any other suitable embodiments are also feasible. In some embodiments, each set of BFD RSs is associated with a CORESET configured with same value of CORESETPoolIndex, and each set of candidate beam RSs is also associated with a CORESET configured with same value of CORESETPoolIndex. In some embodiments, each set of BFD RSs is associated with either the first set of CORESETs C1 or the second set of CORESETs C2. In some embodiments, each set of candidate beam RSs is associated with either the first set of CORESETs C1 or the second set of CORESETs C2.

For example, the network device 110 may configure a set q̅_{0_0} of BFD RSs (for convenience, also referred to as a first set of RSs herein). For example, q̅_{0_0} is configured for TRP 120-1. And a set q̅_{0_1} of BFD RSs (for convenience, also referred to as a second set of RSs herein). For example, q̅_{0_1} is configured for TRP 120-2. That is, the set q̅_{0_0} is associated with C1 and the set q̅_{0_1} is associated with C2. As another example, the network device 110 may configure a set q̅_{1_0} of candidate beam RSs (for convenience, also referred to as a third set of RSs herein). For example, q̅_{1_0} is configured for TRP 120-1. And a set q̅_{1_1} of candidate beam RSs (for convenience, also referred to as a fourth set of RSs herein). For example, q̅_{1_1} is configured for TRP 120-2. That is, the set q̅_{1_0} is associated with C1 and the set q̅_{1_1} is associated with C2.

In some alternative embodiments, the network device 110 may not configure BFD RSs to the terminal device 130. In some alternative embodiments, the network device 110 may only configure one set of BFD RSs (for example, q̅_{0_0}) to the terminal device 130. In some embodiments, a first subset (e.g. S_{0_0}) of RSs in the set q̅_{0_0} may be associated with C1 and a second subset (e.g. S_{0_1}) of RSs in the set q̅_{0_0} may be associated with C2. In some embodiments, the RS in set q̅_{0_0} may be configured/associated with a parameter X (e.g. with value 0 or 1). For example, if the RS in set q̅_{0_0} is not configured/associated with X or the RS in set q̅_{0_0} is configured/associated with X=0, the RS is associated with C1, and if the RS in set q̅_{0_0} is configured/associated with X=1, the RS is associated with C2.

In some alternative embodiments, the network device 110 may only configure one set of candidate beam RSs (for example, q̅_{1_0}) to the terminal device 130. In some embodiments, a first subset (e.g. S_{1_0}) of RSs in the set q̅_{1_0} may be associated with C1 and a second subset (e.g. S_{1_1}) of RSs in the set q̅_{1_0} may be associated with C2. In some embodiments, the RS in set q̅_{1_0} may be configured/associated with a parameter Y (e.g. with value 0 or 1). For example, if the RS in set q̅_{1_0} is not configured/associated with Y or the RS in set q̅_{1_0} is configured/associated with Y=0, the RS is associated with C1, and if the RS in set q̅_{1_0} is configured/associated with Y=1, the RS is associated with C2.

In some embodiments, a RS in the set q̅_{0_0} is different from any one of RSs in the set q̅_{0_1}. In some embodiments, a RS in the set q̅_{0_1} is different from any one of the RSs in the set q̅_{0_0}. For example, one RS can only be included in either one of the sets q̅_{0_0} or q̅_{0_1}. In other words, if one RS is included in the set q̅_{0_0}, it will not be included in the set q̅_{0_1}, or vice versa. In some embodiments, a RS in the set q̅_{1_0} is different from any one of the RSs in the set q̅_{1_1}. In some embodiments, a RS in the set q̅_{1_1} is different from any one of the RSs in the set q̅_{1_0}. For example, one RS can only be included in either one of the sets q̅_{1_0} or q̅_{1_1}. In other words, if one RS is included in the set q̅_{1_0}, it will not be included in the set q̅_{1_1}, or vice versa.

In some embodiments, a RS in the set q̅_{0_0} is not quasi co-located (QCLed) (e.g., QCL type D) with any one of the RSs in the set q̅_{0_1}. In some embodiments, a RS in the set q̅_{0_1} is not quasi co-located (QCLed) (e.g., QCL type D) with any one of the RSs in the set q̅_{0_0}. In some embodiments, a RS in the set q̅_{1_0} is not QCLed (e.g., QCL type D) with a RS in the set q̅_{1_1}. In some embodiments, a RS in the set q̅_{1_1} is not QCLed (e.g., QCL type D) with any one of the RSs in the set q̅_{1_0}.

With reference to FIG. 3, the terminal device 130 determine 302 whether a link failure occurs for at least one of the sets q̅_{0_0} and q̅_{0_1}. In some embodiments where both the sets q̅_{0_0} and q̅_{0_1} are configured, the terminal device 130 may receive configuration information about the sets q̅_{0_0} and q̅_{0_1}, from the network device 110, and determine the sets q̅_{0_0} and q̅_{0_1}, based on the configuration information.

In some embodiments where the set(s) of BFD RS are not configured, for example, the sets q̅_{0_0} and q̅_{0_1}, are not configured. The terminal device 130 may determine the set q̅_{0_0} based on C1 and determine the set q̅_{0_1} based on C2. For example, the set q̅_{0_0} includes periodic CSI-RS resource configuration indexes with same values as the RS indexes in the RS sets indicated/updated by transmission configuration indicator (TCI) state for respective CORESETs (not configured with CORESETPoolIndex or configured with CORESETPoolIndex=0, for example, C1) that the terminal device 130 uses for monitoring PDCCH, and the set q̅_{0_1} includes periodic CSI-RS resource configuration indexes with same values as the RS indexes in the RS sets indicated/updated by TCI state for respective CORESETs (for example, C2) that the terminal device 130 uses for monitoring PDCCH.

In some embodiments where the set(s) of BFD RS are not configured, for example, the sets q̅_{0_0} and q̅_{0_1} are not configured. The terminal device 130 may determine only one set of BFD RS q̅_{0_0} based on C1. For example, the set q̅_{0_0} includes periodic CSI-RS resource configuration indexes with same values as the RS indexes in the RS sets indicated/updated by TCI-State for respective CORESETs (not configured with CORESETPoolIndex or configured with CORESETPoolIndex=0, for example, C1) that the terminal device 130 uses for monitoring PDCCH.

In some alternative embodiments, the terminal device 130 may determine a set of RSs q̅_{0_0} based on C1 and C2, and/or determine, from the set of RSs q̅_{0_0}, a first and second subsets as S_{0_0} and S_{0_1}. For example, the terminal device 130 may determine the set q̅_{0_0} to include periodic CSI-RS resource configuration indexes with same values as the RS indexes in the RS sets indicated/updated by TCI-State for respective CORESETs (i.e., C1 and C2) that the terminal device 130 uses for monitoring PDCCH, and if there are two RS indexes in a transmission configuration indicator (TCI) state, the set q̅_{0_0} may include RS indexes with quasi co-location (QCL)-TypeD configuration for the corresponding TCI states. For example, the terminal device 130 may determine the subset S_{0_0} to include periodic CSI-RS resource configuration indexes with same values as the RS indexes in the RS sets indicated/updated by TCI state for the first set of CORESETs C1 that the terminal device 130 uses for monitoring PDCCH, and if there are two RS indexes in a TCI state, the set q̅_{0_0} may include RS indexes with quasi co-location (QCL)-TypeD configuration for the corresponding TCI states, and the terminal device 130 may determine the subset S_{0_1} to include periodic CSI-RS resource configuration indexes with same values as the RS indexes in the RS sets indicated/updated by TCI state for the second set of CORESETs C2 that the terminal device 130 uses for monitoring PDCCH, and if there are two RS indexes in a TCI state, the set q̅_{0_0} may include RS indexes with quasi co-location (QCL)-TypeD configuration for the corresponding TCI states. As another example, the set q̅_{0_0} may include more than one RS (e.g. P RSs, P≥2), and Q RS (e.g. 1≤Q≤P−1) is the RS with same values as the RS indexes in the RS sets indicated/updated by TCI-State for CORESETs (for example, C1) not configured with CORESETPoolIndex or configured with CORESETPoolIndex=0, and P-Q RS is the RS with same values as the RS indexes in the RS sets indicated/updated by TCI-State for respective CORESET (for example, C2) configured with CORESETPoolIndex=1.

In some embodiments, the set q̅_{0_0} may include at least one RS, and if the RS is with same values as the RS indexes in the RS sets indicated/updated by TCI-State for CORESETs not configured with CORESETPoolIndex or configured with CORESETPoolIndex=0, then the RS is also QCLed (e.g. QCLed with QCL-TypeD) with at least one RS with same values as the RS indexes in the RS sets indicated/updated by TCI-State for CORESETs configured with CORESETPoolIndex=1. Alternatively, if the RS is with same values as the RS indexes in the RS sets indicated/updated by TCI-State for CORESETs configured with CORESETPoolIndex=1, then the RS is also QCLed (e.g. QCLed with QCL-TypeD) with at least one RS with same values as the RS indexes in the RS sets indicated/updated by TCI-State for CORESETs not configured with CORESETPoolIndex or configured with CORESETPoolIndex=0.

In some embodiments where only one set q̅₀ is configured (for example, the set q̅_{0_0} is configured and the set q̅_{0_1} are not configured, or vice versa), and for example, none of the RS in set q̅₀ is QCLed (e.g. QCL-TypeD) with the RS (or the RS with QCL-TypeD configuration) in the RS sets indicated/updated by TCI-state for CORESETs (configured with CORESETPoolIndex=1, for example, C2). For example, the terminal device 130 may determine a further set or subset of BFD RS q̅_{0_1}, which is associated with C2. For example, the terminal device 130 may determine the set q̅₀ is associated with C1 and the further set/subset q̅_{0_1} is associated with C2.

For example, the terminal device 130 may determine the set q̅_{0_0} to include the RS in set q̅₀ and include periodic CSI-RS resource configuration indexes with same values as the RS indexes in the RS sets indicated/updated by TCI-State for respective CORESETs (configured with CORESETPoolIndex=1, for example, C2) that the terminal device 130 uses for monitoring PDCCH, and if there are two RS indexes in a TCI state, the set q̅_{0_0} includes RS indexes with QCL-TypeD configuration for the corresponding TCI states. In an example embodiment, q̅₀ may be the first subset, and the remaining RS in q̅_{0_0} may be the second subset.

As another example, the terminal device 130 may determine the set q̅_{0_1} to include periodic CSI-RS resource configuration indexes with same values as the RS indexes in the RS sets indicated/updated by TCI-State for respective CORESETs (configured with CORESETPoolIndex=1, for example, C2) that the terminal device 130 uses for monitoring PDCCH, and if there are two RS indexes in a TCI state, the set q̅_{0_1} includes RS indexes with QCL-TypeD configuration for the corresponding TCI states.

Upon determining the set q̅_{0_0} and/or q̅_{0_1}, the terminal device 130 may determine whether a link failure occurs for at least one of the sets q̅_{0_0} and q̅_{0_1}. In some embodiments, the terminal device 130 may determine whether a link quality for each RS in the set q̅_{0_0} is worse than a threshold (for convenience, also referred to as a first threshold and denoted as Q_{out,LR} herein). If determining that all the link qualities for all RSs in the set q̅_{0_0} are worse than the first threshold, the terminal device 130 may determine that the link failure occurs for the set q̅_{0_0}. For example, in this way, the terminal device 130 may determine that all beams in TRP 120-1 fail.

In some embodiments, the terminal device 130 may determine whether a link quality for each of RSs in the set q̅_{0_1} is worse than a threshold (for convenience, also referred to as a second threshold and denoted as Q_{out,LR_1} herein). If determining that all the link qualities for all RSs in the set q̅_{0_1} are worse than the second threshold, the terminal device 130 may determine that the link failure occurs for the set q̅_{0_1}. In this way, the terminal device 130 may determine that all beams in TRP 120-2 fail. Of course, any other suitable ways for determination of the link failure are also feasible.

In some embodiments, any of the thresholds Q_{out,LR} and Q_{out,LR_1} may be a predetermined value. For example, the threshold Q_{out,LR} may be same or different from the Q_{out,LR_1} threshold. For example, if the terminal device 130 is not provided CORESETPoolIndex or is provided CORESETPoolIndex with a value 0 for a first set of CORESET(s) (C1) on active DL BWP(s) of a serving cell, and if the terminal device 130 is provided CORESETPoolIndex with a value of 1 for a second set of CORESET(s) (C2) on active DL BWP(s) of the serving cell and/or if the terminal device 130 is configured with multi-TRP/partial beam failure recovery, the threshold Q_{out,LR} may correspond to the default value of rlmInSyncOutOfSyncThreshold, as described in [10, TS 38.133] for Qₒᵤₜ. For example, the threshold Q_{out,LR_1} may also correspond to the default value of rlmInSyncOutOfSyncThreshold, as described in [10, TS 38.133] for Qₒᵤₜ. For another example, the threshold Q_{out,LR_1} may correspond to a different default value of rlmInSyncOutOfSyncThreshold−1, as described in [10, TS 38.133] for Q_{out_1}.

In some alternative embodiments, any of the thresholds Q_{out,LR} and Q_{out,LR_1} may be configured. For example, an offset (e.g. Q_{out,LR_offset}) may be configured to the terminal device 130, and the threshold Q_{out,LR_1}=Q_{out,LR}+Q_{out,LR_offset} is applied for C2. It should be noted that the thresholds Q_{out,LR} and Q_{out,LR_1} may be any other suitable values. Further, the thresholds Q_{out,LR} and Q_{out,LR_1} may be different or same values.

Upon determining that the link failure occurs for one of the sets q̅_{0_0} and q̅_{0_1}, the terminal device 130 transmits 303 a BFR signaling to the network device 110. For example, the BFR signaling may be a signaling for link recovery (also referred to as BFR signaling). For another example, the signaling may comprise an indication about at least one of C1 and C2 associated with the at least one of the sets q̅_{0_0} and q̅_{0_1}. For example, in this way, a BFR procedure can be triggered per TRP or per set of CORESETs.

In some embodiments where the link failure occurs for the set q̅_{0_0}, a BFR procedure will be triggered. For example, for the first set of CORESETs C1. For another example, for TRP 120-1. In these embodiments, the terminal device 130 may determine a subset of RSs (also referred to as at least one first RS and denoted as q_{new_1} herein) from the set q̅_{1_0}, and transmit the BFR signalling comprising the indication about C1 and information about the determined subset.

In some embodiments where the link failure occurs for the set q̅_{0_1}, a BFR procedure will be triggered, for example, for the second set of CORESETs C1. For another example, for TRP 120-2. In these embodiments, the terminal device 130 may determine a subset of RSs (also referred to as at least one second RS and denoted as q_{new_2} herein) from the set q̅_{1_1}, and transmit the BFR signalling comprising the indication about C2 and information about the determined subset.

In some embodiments where both the sets q̅_{1_0} and q̅_{1_1} are configured, the terminal device 130 may receive information about the sets q̅_{1_0} and q̅_{1_1} from the network device 110, and determine, based on the information, the sets q̅_{1_0} and q̅_{1_1} from RSs received from the network device 110.

In some embodiments where only a plurality of RSs for link recovery is configured, the terminal device 130 may determine a first part associated with C1 in the plurality of RSs as the set q̅_{1_0}, and determine a second part associated with C2 in the plurality of RSs as the set q̅_{1_1}. In some embodiments, the terminal device 130 may determine a first part configured with a first value of a parameter Y in the plurality of RSs as the set q̅_{1_0}, and determine a second part configured with a second value of the parameter Y in the plurality of RSs as the set q̅_{1_1}. The first and second values can be any suitable values, for example, 0 or 1. In some embodiments, the terminal device 130 may determine a first part not configured with a parameter Y in the plurality of RSs as the set q̅_{1_0}, and determine a second part configured with the parameter Y in the plurality of RSs as the set q̅_{1_1}. In some embodiments, the terminal device 130 may determine a first part not configured with a parameter Y or configured with a first value of the parameter Y in the plurality of RSs as the set q̅_{1_0}, and determine a second part configured with a second value of the parameter Y in the plurality of RSs as the set q̅_{1_1}. For example, the first and second values can be any suitable values, for example, 0 or 1.

In some embodiments, if the link failure occurs for at least one set or subset of the BFD RS, the terminal device 130 may indicate to higher layers at least one of an indication or an index about the associated set of CORESETs corresponding to the set/subset of the BFD RS, an indication or index about the set/subset of BFD RS, whether there is at least one periodic CSI-RS configuration index and/or SS/PBCH block index (denoted as q_{new} herein) from the corresponding set of RS (i.e. corresponding q̅_{1_0} or q̅_{1_1} or S_{1_0} or S_{1_1}) for new beam candidates with corresponding Layer-1 Reference Signal Received Power (L1-RSRP) measurements that are larger than or equal to the corresponding threshold (Q_{in,LR} or Q_{in,LR_1}), the periodic CSI-RS configuration indexes and/or SS/PBCH block indexes from the corresponding set of RS, and the corresponding L1-RSRP measurements that are larger than or equal to the corresponding threshold, if any. In some embodiments, the terminal device may transmit a BFR signaling comprising at least one of the indication or an index about the associated set of CORESETs corresponding to the set/subset of the BFD RS, an indication or index about the set/subset of BFD RS, an indication (also referred to as second indication herein) about presence of q_{new} and index(es) q_{new} for a periodic CSI-RS configuration or for a SS/PBCH block).

In some embodiments where the link failure occurs for the set q̅_{0_0} or the subset S_{0_0}, the terminal device 130 may determine whether there is a first RS (denoted as q_{new_1} herein) from the set q̅_{1_0} or subset S_{1_0} whose received power is larger than or equal to a first threshold (denoted as Q_{in,LR} herein). For example, if determining that there is q_{new_1} from the set q̅_{1_0} or subset S_{1_0}, the terminal device 130 may transmit, in the BFR signaling with the indication about the set C1, an indication (also referred to as second indication herein) about presence of q_{new_1} and information about q_{new_1} (for example, index(es) q_{new_1} for a periodic CSI-RS configuration or for a SS/PBCH block). For example, if determining that there is no q_{new_1} from the set q̅_{1_0} or subset S_{1_0}, the terminal device 130 may transmit, in the BFR signaling with the indication about the set C1, an indication (also referred to as second indication herein) about absence of q_{new_1}.

In some embodiments, if the link failure occurs for the set q̅_{0_0} or the subset S_{0_0}, the terminal device 130 may indicate to higher layers at least one of an indication or an index about the set of CORESETs C1 (for example, a value of A, and A is an integer. For example, A=0), an indication or index about the set/subset of BFD RS q̅_{0_0} or S_{0_0} (for example, a value of A, and A is an integer. For example, A=0), whether there is at least one periodic CSI-RS configuration index and/or SS/PBCH block index from the set q̅_{1_0} or subset S_{1_0} with corresponding L1-RSRP measurements that are larger than or equal to the corresponding threshold Q_{in,LR}, the periodic CSI-RS configuration indexes and/or SS/PBCH block indexes from the set q̅_{1_0} or subset S_{1_0}, and the corresponding L1-RSRP measurements that are larger than or equal to the corresponding threshold, if any. In some embodiments, the terminal device 130 may transmit a BFR signaling comprising at least one of the indication or an index about the associated set of CORESETs C1 (for example, a value of F, and F is an integer. For example, F=0), an indication or index about the set q̅_{1_0} or subset S_{1_0} (for example, a value of F, and F is an integer. For example, F=0), an indication (also referred to as second indication herein) about presence of q_{new_1} and index(es) q_{new_1} for a periodic CSI-RS configuration or for a SS/PBCH block.

For example, if two sets q̅_{0_0} and q̅_{0_1} configured/determined or one set including two subsets of RS (S_{0_0} and S_{0_1}) each associated with a set of CORESETs C1 or C2 respectively, (the UE may monitor the different sets/subsets of RS), and if/when the radio link quality for all corresponding resource configuration in the set q̅_{0_0} or subset S_{0_0} is worse than the threshold Q_{out,LR}, the physical layer in the UE provides an indication (for example, associated with a parameter W (e.g. with W=A, e.g. 0)) to higher layer, the terminal device 130 may indicate to higher layers whether there is at least one periodic CSI-RS configuration index and/or SS/PBCH block index from the set q̅_{1_0} or subset S_{1_0} with corresponding L1-RSRP measurements that are larger than or equal to the Q_{in,LR} threshold, and provides the periodic CSI-RS configuration indexes and/or SS/PBCH block indexes from the set q̅_{1_0} or subset S_{1_0}, if any.

In some embodiments, the terminal device 130 may transmit in a PUSCH (e.g. medium access control (MAC) control element (CE)) providing at least one of a parameter V (e.g. index(es) or an index, e.g. with value 0) for corresponding set of CORESETs (C1) with radio link quality worse than Q_{out,LR}, indication(s) of presence of q_{new_1} for corresponding set of CORESETs (C1), and index(es) for a periodic CSI-RS configuration or for a SS/PBCH block provided by higher layer, if any.

For example, the parameter V may be a parameter to indicate the set/subset (e.g. q̅_{1_0} or q̅_{1_1} or S_{1_0} or S_{1_1}) for the new identified RS. Or the UE may provide a parameter to indicate the set of the CORESETs (e.g. C1 or C2) or to indicate the value of CORESETPoolIndex). E.g. in this case, the parameter V is to indicate set q̅_{1_0} or subset S_{1_0} or set q̅_{0_0} or subset S_{0_0} or set C1 (CORESETs with CORESETPoolIndex=0 or not configured with CORESETPoolIndex) (e.g. V=F, e.g. F=0).

In some alternative embodiments, the parameter V may not need to be explicitly reported. For example, if the reported index of CSI-RS and/or SS/PBCH block is included in set q̅_{1_0} or subset S_{1_0}, the set of CORESETs is assumed to be C1. For another example, if the reported index of CSI-RS and/or SS/PBCH block is included in set q̅_{1_1} or subset S_{1_1}, the set of CORESETs is assumed to be C2. In this way, information about the failed TRP or failed set of CORESETs can be implicitly reported. It should be noted that this is merely an example, and any other suitable ways for indication of the failed set of CORESETs or TRP are also feasible.

In some embodiments where the link failure occurs for the set q̅_{0_1} or the subset S_{0_1}, the terminal device 130 may determine whether there is a second RS (denoted as q_{new_2} herein) from the set q̅_{1_1} or the subset S_{1_1} whose received power is larger than or equal to a second threshold (denoted as Q_{in,LR_1} herein). For example, if determining that there is q_{new_2} from the set q̅_{1_1} or subset S_{1_1}, the terminal device 130 may transmit, in the BFR signaling with the indication about the set C2, an indication (also referred to as third indication herein) about presence of q_{new_2} and information about q_{new_2} (for example, index(es) q_{new_2} for a periodic CSI-RS configuration or for a SS/PBCH block). For example, if determining that there is no q_{new_2} from the set q̅_{1_1} or the subset S_{1_1}, the terminal device 130 may transmit, in the BFR signaling with the indication about the set C2, an indication (also referred to as fourth indication herein) about absence of q_{new_2}.

In some embodiments, if the link failure occurs for the set q̅_{0_1} or the subset S_{0_1}, the terminal device 130 may indicate to higher layers at least one of an indication or an index about the set of CORESETs C2 (for example, a value of B, and B is an integer. For example, B=1), an indication or index about the set/subset of BFD RS q̅_{0_1} or S_{0_1} (for example, a value of B, and B is an integer. For example, B=1), whether there is at least one periodic CSI-RS configuration index and/or SS/PBCH block index from the set q̅_{1_1} or subset S_{1_1} with corresponding L1-RSRP measurements that are larger than or equal to the corresponding threshold Q_{in,LR} or Q_{in,LR_1}, the periodic CSI-RS configuration indexes and/or SS/PBCH block indexes from the set q̅_{1_1} or subset S_{1_1}, and the corresponding L1-RSRP measurements that are larger than or equal to the corresponding threshold, if any. In some embodiments, the terminal device 130 may transmit a BFR signaling comprising at least one of the indication or an index about the associated set of CORESETs C2 (for example, a value of G, and G is an integer. For example, G=1), an indication or index about the set q̅_{1_1} or subset S_{1_1} (for example, a value of G, and G is an integer. For example, G=1), an indication (also referred to as second indication herein) about presence of q_{new_2} and index(es) q_{new_2} for a periodic CSI-RS configuration or for a SS/PBCH block.

For example, If two sets q̅_{0_0} and q̅_{0_1} configured/determined or one set including two subsets of RS (S_{0_0} and S_{0_1}) each associated with a set of CORESETs C1 or C2 respectively, (the UE may monitor the different sets/subsets of RS), and if/when the radio link quality for all corresponding resource configuration in the set q̅_{0_1} or subset S_{0_1} is worse than the threshold Q_{out,LR} or threshold Q_{out,LR_1}, the physical layer in the UE provides an indication (for example, associated with a parameter W (e.g. with W=B, e.g. 1)) to higher layer, and/or if two sets of q̅_{1_0} and q̅_{1_1} configured or one set including two subsets of RS (S_{1_0} and S_{1_1}) each associated with a set of CORESETs C1 or C2 respectively, the terminal device 130 may indicate to higher layers whether there is at least one periodic CSI-RS configuration index and/or SS/PBCH block index from the set q̅_{1_1} or subset S_{1_1} with corresponding L1-RSRP measurements that are larger than or equal to the Q_{in,LR} or Q_{in,LR_1} threshold, and provides the periodic CSI-RS configuration indexes and/or SS/PBCH block indexes from the set q̅_{1_1} or subset S_{1_1}, if any.

In some embodiments, the terminal device 130 may transmit in a (first) PUSCH (e.g. MAC CE) providing at least one of a parameter V (e.g. index(es) or an index) for corresponding set of CORESETs (C2) with radio link quality worse than Q_{out,LR} or Q_{out,LR_1}, indication(s) of presence of q_{new_2} for corresponding set of CORESETs (C2), and index(es) for a periodic CSI-RS configuration or for a SS/PBCH block provided by higher layer, if any.

For example, the parameter V may be a parameter to indicate the set/subset (e.g. q̅_{1_0} or q̅_{1_1}) for the new identified RS. Or the UE may provide a parameter to indicate the set of the CORESETs (e.g. C1 or C2) or to indicate the value of CORESETPoolIndex). E.g. in this case, the parameter is to indicate set q̅_{1_1} or subset S or set q̅_{0_1} or subset S_{0_1} or set C2 (CORESETs with CORESETPoolIndex=1) (e.g. V=G, e.g. G=1).

In some alternative embodiments, the parameter V may not need to be explicitly reported. For example, if the reported index of CSI-RS and/or SS/PBCH block is included in set q̅_{1_1} or subset S_{1_1}, the set of CORESETs is assumed to be C2. For another example, if the reported index of CSI-RS and/or SS/PBCH block is included in set q̅_{1_0} or subset S_{1_0}, the set of CORESETs is assumed to be C1. In this way, information about the failed TRP or the failed set of CORESETs can be implicitly reported. It should be noted that this is merely an example, and any other suitable ways for indication of the failed set of CORESETs or TRP are also feasible.

Upon receiving the BFR signaling, the network device 110 performs 304 a link recovery procedure for a TRP or for a set of CORESETs. In some embodiments where the link failure occurs for the set q̅_{0_0} or subset S_{0_0} and/or q_{new_1} presents, the network device 110 transmits a physical downlink control channel (PDCCH) in the corresponding set of CORESETs C1 using/with the same antenna port (for example, the DMRS port for the PDCCH) quasi co-location parameters as the ones associated with the corresponding index(ex) q_{new_1}. In some embodiments, if the link failure occurs for the set q̅_{0_0} or subset S_{0_0} and/or q_{new_1} presents, the terminal device 130 may monitor PDCCH in the set of CORESETs C1 using/with the same antenna port (for example, the DMRS port for the PDCCH) quasi co-location parameters as the ones associated with the corresponding index(ex) q_{new_1}. In some embodiments where the link failure occurs for the set and/or q_{new_2} presents, the network device 110 transmits a PDCCH in the corresponding set of CORESETs C2 using/with the same antenna port (for example, the DMRS port for the PDCCH) quasi co-location parameters as the ones associated with the corresponding index(ex) q_{new_2} In some embodiments, if the link failure occurs for the set q̅_{0_1} or subset S_{0_1} and/or q_{new_2} presents, the terminal device 130 may monitor PDCCH in the set of CORESETs C2 using/with the same antenna port (for example, the DMRS port for the PDCCH) quasi co-location parameters as the ones associated with the corresponding index(ex) q_{new_2}.

The terminal device 130 monitors 305 the downlink control channel in at least one of the sets C1 and C2. If the terminal device 130 receives a response to the BFR signaling via the downlink control channel, the beam failure is recovered.

In some embodiments where the link failure occurs for the set q̅_{0_0} or subset S_{0_0}, the terminal device 130 may monitor PDCCH in the set C1 using the same antenna port quasi co-location parameters as the ones associated with the corresponding index(es) q_{new_1}, if any. In some alternative embodiments, the terminal device 130 may monitor PDCCH in the set C2 (using the antenna port quasi co-location parameters configured/updated for the CORESETs C2). For example, the PDCCH monitored/received in CORESETs C2 may be used to update TCI states/QCL parameters for the CORESET(s) in C1.

In some embodiments, the terminal device 130 may transmit PUCCH on a PUCCH-Scell or on Pcell/Pscell using a same spatial domain filter as the one corresponding to q_{new_1} for periodic CSI-RS or SS/PBCH block reception, and using a power determined with at least one of qᵤ=0, q_{d}=q_{new_1}, and l=W or l is determined by the configured value of closedLoopIndex corresponding to the set C1 if the UE is provided twoPUCCH-PC-AdjustmentStates and PUCCH-SpatialRelationInfo and l=0 if the UE is not provided twoPUCCH-PC-AdjustmentStates or PUCCH-SpatialRelationInfo (or l=0). For example, qᵤ denotes an index of parameter for a first parameter of power control calculation. For example, q_{d} denotes an index for RS resource for a second parameter of pathloss or power control calculation. For example, l denotes an index of power control adjustment state.

In some embodiments where the link failure occurs for the set q̅_{0_1} or subset S_{0_1}, the terminal device 130 may monitor PDCCH in the set C2 using the same antenna port quasi co-location parameters as the ones associated with the corresponding index(es) q_{new_2}, if any. In some alternative embodiments, the terminal device 130 may monitor PDCCH in the set C1 (using the antenna port quasi co-location parameters configured/updated for the CORESETs C1). For example, the PDCCH monitored/received in CORESETs C1 may be used to update TCI states/QCL parameters for the CORESET(s) in C2.

In some embodiments, the terminal device 130 may transmit PUCCH on a PUCCH-Scell or on Pcell/Pscell using a same spatial domain filter as the one corresponding to q_{new_2} for periodic CSI-RS or SS/PBCH block reception, and using a power determined with at least one of qᵤ=0, q_{d}=q_{new_2}, and l=W or l is determined by the configured value of closedLoopIndex corresponding to the set C2 if the terminal device 130 is provided twoPUCCH-PC-AdjustmentStates and PUCCH-SpatialRelationInfo and 1=0 if the terminal device 130 is not provided twoPUCCH-PC-AdjustmentStates or PUCCH-SpatialRelationInfo (or l=0 or l=1). For example, qᵤ denotes an index of parameter for a first parameter of power control calculation. For example, q_{d} denotes an index for RS resource for a second parameter of pathloss or power control calculation. For example, l denotes an index of power control adjustment state.

In some embodiments, if the terminal device 130 determines 306 that the link qualities of RSs in the set q̅_{0_0} or subset S_{0_0} are less than the Q_{out,LR} and the link qualities of RSs in the set q̅_{0_1} or subset S_{0_1} are less than the Q_{out,LR_1}, the terminal device 130 may transmit 307 a further signaling for link recovery to the network device 110, the further signaling comprising a further indication about both the sets C1 and C2.

In some embodiments, the terminal device 130 may determine whether there is q_{new_1} from the set q̅_{1_0} or subset S_{1_0}, and determine whether there is q_{new_2} from the set q̅_{1_1} or subset S_{1_1}. For example, if determining that at least one of q_{new_1} and q_{new_2} present, the terminal device 130 may transmit, in the further signaling, the further indication and information about at least one of q_{new_1} and q_{new_2}.

For example, if two sets q̅_{0_0} and q̅_{0_1} configured/determined or one set including two subsets of RS (S_{0_0} and S_{0_1}) each associated with a set of CORESETs C1 or C2 respectively, (the terminal device 130 may monitor the different sets/subsets of RS), if/when the radio link quality for all corresponding resource configuration in the set q̅_{0_0} or subset S_{0_0} is worse than the threshold Q_{out,LR}, and if/when the radio link quality for all corresponding resource configuration in the set q̅_{0_1} or subset S_{0_1} is worse than the threshold Q_{out,LR} or Q_{out,LR_1}, the physical layer in the terminal device 130 provides an indication (not associated with a parameter W or associated with a parameter (e.g. with W=C, e.g. 2 or W=A, e.g. 0) to higher layer.

In some embodiments, A and/or B and/or C are a non-negative integer. For example, A may be any one of {0, 1, 2}. For another example, A=0. For example, B may be any one of {0, 1, 2}. For another example, B=1. For example, C may be any one of {0, 1, 2}. For another example, C=2. For another example, the value of A may be different from the value of B. For another example, the value of A may be different from the value of C. For another example, the value of A may be different from the value of C. In some embodiments, F and/or G and/or H are non-negative integer. For example, F may be any one of {0, 1, 2}. For another example, F=0. For example, G may be any one of {0, 1, 2}. For another example, G=1. For example, H may be any one of {0, 1, 2}. For another example, H=2. For another example, the value of F may be different from the value of G. For another example, the value of F may be different from the value of H. For another example, the value of G may be different from the value of H.

In some embodiments, if two sets of q̅_{1_0} and q̅_{1_1} configured or one set including two subsets of RS (S_{1_0} and S_{1_1}) each associated with a set of CORESETs C1 or C2 respectively, the terminal device 130 may indicate to higher layers whether there is at least one periodic CSI-RS configuration index and/or SS/PBCH block index from the set q̅_{1_0} or subset S_{1_0} with corresponding L1-RSRP measurements that are larger than or equal to the Q_{in,LR} threshold, and provides the periodic CSI-RS configuration indexes and/or SS/PBCH block indexes from the set q̅_{1_0} or subset S_{1_0}, if any. And/or the terminal device 130 may indicate to higher layers whether there is at least one periodic CSI-RS configuration index and/or SS/PBCH block index from the set q̅_{1_1} or subset S_{1_1} with corresponding L1-RSRP measurements that are larger than or equal to the Q_{in,LR} or Q_{in,LR_1} threshold, and provides the periodic CSI-RS configuration indexes and/or SS/PBCH block indexes from the set q̅_{1_1} or subset S_{1_1}, if any.

In some embodiments, the terminal device 130 may transmit in a PUSCH (e.g. MAC CE) providing at least one of a parameter V (e.g. index(es) or an index, e.g. with value 2 or value 0) for corresponding set of CORESETs (C1) with radio link quality worse than Q_{out,LR}, indication(s) of presence of q_{new_1} for corresponding set of CORESETs (C1), and index(es) q_{new_1} for a periodic CSI-RS configuration or for a SS/PBCH block provided by higher layer, if any. And/or the PUSCH (e.g. MAC CE) may provide at least one of a parameter V (e.g. index(es) or an index, e.g. with value 2 or value 1) for corresponding set of CORESETs (C2) with radio link quality worse than Q_{out,LR} or Q_{out,LR_1}, indication(s) of presence of q_{new_2} for corresponding set of CORESETs (C2), and index(es) q_{new_2} for a periodic CSI-RS configuration or for a SS/PBCH block provided by higher layer, if any.

In some embodiments, the parameter V is to indicate both of the set q̅_{1_0} and q̅_{1_1} or both of the subsets S_{1_0} and S_{1_1} or both of the set q̅_{0_0} and q̅_{0_1} or both of the subsets S_{0_0} and S_{0_1} or both the sets C1 and C2 (e.g. V=H, e.g. H=2). In some embodiments, two sets of parameters are reported, each corresponds to parameter V, and corresponding indication(s) of presence of q_{new}, and index(es) for a periodic CSI-RS configuration or for a SS/PBCH block provided by higher layer. In some embodiments, only one of q_{new_1} and q_{new_2} is provided in the PUSCH (e.g. MAC CE), and the one of q_{new_1} and q_{new_2} which is with a larger value of L1-RSRP. And/or the parameter V is provided, which is to indicate the set of CORESETs. (V=F or G. e.g. V=0 or 1). For example, if L1-RSRP of q_{new_1} and q_{new_2} is same, q_{new_1} and corresponding parameters may be provided.

In some embodiments, if only q_{new_1} is present, the terminal device 130 may monitor a downlink control channel (e.g. PDCCH) in the set C1. For example, if only q_{new_1} is present, the UE may monitor PDCCH in the set of CORESETs C1 using the same antenna port quasi co-location parameters as the ones associated with the corresponding index(es) q_{new_1}.

In some embodiments, if only q_{new_2} is present, the terminal device 130 may monitor a downlink control channel (e.g. PDCCH) in the set C2. For example, if only q_{new_2} is present, the terminal device 130 may monitor PDCCH in the set of CORESETs C2 using the same antenna port quasi co-location parameters as the ones associated with the corresponding index(es) a q_{new_2}.

In some embodiments, if both q_{new_1} and q_{new_2} are present, the terminal device 130 may monitor a downlink control channel (e.g. PDCCH) in the set C1. For example, the terminal device 130 may monitor PDCCH in the set of CORESETs C1 using the same antenna port quasi co-location parameters as the ones associated with the corresponding index(es) q_{new_1}.

In some alternative embodiments, if both q_{new_1} and q_{new_2} are present, the terminal device 130 may monitor a downlink control channel (e.g. PDCCH) in at least one of the sets C1 and C2. In some alternative embodiments, if both q_{new_1} and q_{new_2} are present, the terminal device 130 may monitor a downlink control channel (e.g. PDCCH) in only one of the sets C1 or C2, which corresponds to q_{new_1} or q_{new_2} with a larger value of L1-RSRP. For example, the terminal device 130 may monitor PDCCH in the corresponding set of CORESETs using the same antenna port quasi co-location parameters as the ones associated with the corresponding index(es) q_{new_1} or q_{new_2} (with larger reported L1-RSRP).

In some embodiments, if only one of q_{new_1} or q_{new_2} is present, the terminal device 130 may transmit PUCCH on a PUCCH-Scell or on Pcell/Pscell using a same spatial domain filter as the one corresponding to q_{new_1} or q_{new_2} which is present for periodic CSI-RS or SS/PBCH block reception, and using a power determined with qᵤ=0, q_{d}=q_{new_1} or q_{new_2} which is present, and l is determined by the configured value of closedLoopIndex corresponding to the set C1 or C2 which corresponds to the present q_{new_1} or q_{new_2} if the terminal device 130 is provided twoPUCCH-PC-AdjustmentStates and PUCCH-SpatialRelationInfo and l=0 if the UE is not provided twoPUCCH-PC-AdjustmentStates or PUCCH-SpatialRelationInfo (or l=0). For example, qᵤ denotes an index of parameter for a first parameter of power control calculation. For example, q_{d} denotes an index for RS resource for a second parameter of pathloss or power control calculation. For example, l denotes an index of power control adjustment state.

In some embodiments, if both q_{new_1} and q_{new_2} are present, the terminal device 130 may transmit PUCCH on a PUCCH-Scell or on Pcell/Pscell using a same spatial domain filter as the one corresponding to q_{new_1} which is present for periodic CSI-RS or SS/PBCH block reception, and using a power determined with qᵤ=0, q_{d}=q_{new_1}, and l is determined by the configured value of closedLoopIndex corresponding to the set C1 if the UE is provided twoPUCCH-PC-AdjustmentStates and PUCCH-SpatialRelationInfo and l=0 if the UE is not provided twoPUCCH-PC-AdjustmentStates or PUCCH-SpatialRelationInfo (or l=0). For example, qᵤ denotes an index of parameter for a first parameter of power control calculation. For example, q_{d} denotes an index for RS resource for a second parameter of pathloss or power control calculation. For example, l denotes an index of power control adjustment state.

In some alternative embodiments, the terminal device 130 may transmit PUCCH on a PUCCH-Scell or on Pcell/Pscell using a same spatial domain filter as the one corresponding to q_{new_1} or q_{new_2} with larger L1-RSRP for periodic CSI-RS or SS/PBCH block reception, and using a power determined with qᵤ=0, q_{d}=q_{new_1} or q_{new_2} with larger L1-RSRP, and l is determined by the configured value of closedLoopIndex corresponding to the set C1 or C2 which corresponds to q_{new_1} or q_{new_2} with larger L1-RSRP if the UE is provided twoPUCCH-PC-AdjustmentStates and PUCCH-SpatialRelationInfo and l=0 if the UE is not provided twoPUCCH-PC-AdjustmentStates or PUCCH-SpatialRelationInfo (or l=0). For example, qᵤ denotes an index of parameter for a first parameter of power control calculation. For example, q_{d} denotes an index for RS resource for a second parameter of pathloss or power control calculation. For example, l denotes an index of power control adjustment state.

In some embodiments, the terminal device 130 may only select one RS for link recovery (i.e., for new beam candidate) from the sets q̅_{1_0} and q̅_{1_1} or from the subset S_{1_0} and S_{1_1}. For example, the terminal device 130 may only monitor and/or report the RS from set q̅_{1_0} or from the subset S_{1_0} for new beam candidate. For example, for Pcell or PScell, upon request from higher layers, the terminal device 130 may provide to higher layers the periodic CSI-RS configuration indexes and/or SS/PBCH block indexes from the set q̅_{1_0} or from the subset S_{1_0}, and the corresponding L1-RSRP that is larger than or equal to the threshold power Q_{in,LR}.

For another example, for Scell, upon request from higher layers, the terminal device 130 may indicate to higher layers whether there is at least one periodic CSI-RS configuration index and/or SS/PBCH block index from the set q̅_{1_0} or from the subset S_{1_0}, with corresponding L1-RSRP measurements that are larger than or equal to the Q_{in,LR} threshold, and provide the periodic CSI-RS configuration indexes and/or SS/PBCH block indexes from the set q̅_{1_0} or from the subset S_{1_0} and the corresponding L1-RSRP measurements that are larger than or equal to the Q_{in,LR} threshold, if any.

In some embodiments, if both q_{new_1} and q_{new_2} are present, the terminal device 130 may report the RS with a larger value of L1-RSRP. In some embodiments, if the values of L1-RSRP are same, the terminal device 130 may report RS associated with q_{new_1}. Of course, it is also feasible to report RS associated with q_{new_2}.

In some embodiments, for Pcell or PScell, upon request from higher layers, the terminal device 130 may provide to higher layers the periodic CSI-RS configuration indexes and/or SS/PBCH block indexes from the set q̅_{1_0} or set q̅_{1_1} or from the subset S_{1_0} or from the subset S (which corresponds to larger L1-RSRP), and the corresponding L1-RSRP measurements that are larger than or equal to the Q_{in,LR} threshold.

In some embodiments, for Scell, (if RS in only one set of q̅_{1_0} and q̅_{1_1} or only one subset of S_{1_0} and S satisfies), upon request from higher layers, the terminal device 130 may indicate to higher layers whether there is at least one periodic CSI-RS configuration index and/or SS/PBCH block index from either the set q̅_{1_0} or the set q̅_{1_1} or from either the subset S_{1_0} or the subset S_{1_1}, with corresponding L1-RSRP measurements that are larger than or equal to the Q_{in,LR} threshold, and provides the periodic CSI-RS configuration indexes and/or SS/PBCH block indexes from either the set q̅_{1_0} or q̅_{1_1} or from either the subset S_{1_0} or the subset S_{1_1} and the corresponding L1-RSRP measurements that are larger than or equal to the Q_{in,LR} threshold, if any.

In some embodiments, for Scell, (if RS in both sets of q̅_{1_0} and q̅_{1_1} or in both the subsets S_{1_0} and S_{1_1} satisfies), upon request from higher layers, the terminal device 130 may indicate to higher layers whether there is at least one periodic CSI-RS configuration index and/or SS/PBCH block index from either the set q̅_{1_0} or the set q̅_{1_1} or from either the subset S_{1_0} or the subset S_{1_1} with larger value of L1-RSRP), with corresponding L1-RSRP measurements that are larger than or equal to the Q_{in,LR} threshold, and provides the periodic CSI-RS configuration indexes and/or SS/PBCH block indexes from either the set q̅_{1_0} or q̅_{1_1} or from either the subset S_{1_0} or the subset S_{1_1} with larger value of L1-RSRP and the corresponding L1-RSRP measurements that are larger than or equal to the Q_{in,LR} threshold, if any.

In some embodiments, if both q_{new_1} and q_{new_2} are reported, L1-RSRP with larger value will be reported, and/or the corresponding index of CORESETs will be reported. Differential L1-RSRP of the other one will be reported, and for example, the corresponding index of CORESETs may not be reported.

In some embodiments, if the terminal device 130 determines that the link qualities of RSs in the set q̅_{0_0} or subset S_{0_0} are less than the Q_{out,LR} and the link qualities of RSs in the set q̅_{0_1} or subset S_{0_1} are less than the Q_{out,LR_1}, and/or if both q_{new_1} and q_{new_2} are present, the terminal device 130 may transmit a signal or a channel (for example, PRACH) to the network device 110. The sequence for the signal may be used to indicate q_{new_1}, and the time and/or frequency resource for the signal transmission may be used to indicate q_{new_2}.

In some embodiments, the terminal device 130 may report the capability for whether partial BFR is supported.

Return to FIG. 3, in some embodiments where a link failure occurs for the set q̅_{0_0} or subset S_{0_0}, if determining 308 that the link quality of each RS in the set q̅_{0_1} or the subset S_{0_1} is less than Q_{out,LR_1} and downlink control information for the set C1 is received via the downlink control channel, the terminal device 130 may transmit 309 a further signaling for link recovery to the network device 110, the further signaling comprising a third indication about the set C2. In this way, a link recovery procedure will be separately triggered for another TRP or for another set of CORESETs. Of course, any other suitable ways for determination of the link failure are also feasible.

For example, if/when the radio link quality for all corresponding resource configuration in either one of (the set q̅_{0_0} or subset S_{0_0}) or (the set q̅_{0_1} or subset S_{0_1}) (e.g. J1) is worse than the threshold Q_{out,LR} or threshold Q_{out,LR_1}, partial BFR (as disclosed in some embodiments) is processed, and if before the terminal device 130 monitors the corresponding PDCCH, the radio link quality for all corresponding resource configuration in the other one of (the set q̅_{1_0} or subset S_{1_0}) or (the set q̅_{1_1} or subset S_{1_1}) (e.g. J2) is worse than the threshold Q_{out,LR} or threshold Q_{out,LR_1}, and if the terminal device 130 receives the PDCCH successfully (before a timing which may be predetermined or configured via at least one of RRC, MAC CE and DCI), the terminal device 130 will apply partial BFR (as disclosed in some embodiments) for J2. In some embodiments, if the terminal device 130 does not receive the PDCCH successfully (before a timing which may be predetermined or reported/determined as capability of the terminal device 130 or reported/determined as capability of the terminal device 130 or configured via at least one of RRC, MAC CE and DCI), the terminal device 130 will apply normal BFR (current spec procedure, for example as disclosed in Clause 6 in TS 38.213 v16.2.0) for the BWP/cell.

In some embodiments, for a BWP/cell configured with two sets of CORESETs C1 and C2, BFR or LRR may be applied in order of partial BFR (as disclosed in some embodiments) and then normal BFR or LRR (current spec procedure, for example as disclosed in Clause 6 in TS 38.213 v16.2.0). In some embodiments, for Pcell and Pscell, if only one of (the set q̅_{0_0} or subset S_{0_0}) or (the set q̅_{0_1} or subset S_{0_1}) failed, the signaling for BFR or LRR (as disclosed in some embodiments) may be transmitted with PUCCH, otherwise, PRACH will be applied. In some embodiments, for one Scell, if only one of (the set q̅_{0_0} or subset S_{0_0}) or (the set q̅_{0_1} or subset S_{0_1}) failed, the signaling for BFR or LRR (as disclosed in some embodiments) may be transmitted with PUCCH on the Scell or on the corresponding Pcell/Pscell or on the corresponding PUCCH-Scell if PUCCH group is configured, otherwise, normal BFR or LRR (current spec procedure, for example as disclosed in Clause 6 in TS 38.213 v16.2.0) may be applied with PUCCH on Pcell/Pscell or on PUCCH-Scell if PUCCH group is configured. In some embodiments, If PUCCH with signaling of partial BFR or LRR and PUCCH with signaling of normal BFR or LRR (on the same Cell) overlaps, the PUCCH with signaling of partial BFR or LRR will be dropped.

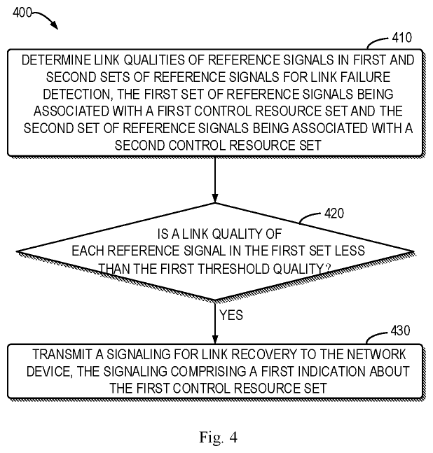

With the process of FIG. 3, a procedure for BFR per TRP or per set of CORESETs is provided. An increased latency can be avoided and an improved efficiency can be obtained. Correspondingly, embodiments of the present disclosure also provide methods and devices of communication for BFR. This will be described below in connection with FIGS. 4-6.

FIG. 4 illustrates a flowchart of an example method q̅_{0_0} for BFR implemented at a terminal device in accordance with some embodiments of the present disclosure. The method q̅_{0_0} can be implemented at the terminal device 130 shown in FIG. 1. For the purpose of discussion, the method q̅_{0_0} will be described with reference to FIG. 1. It is to be understood that the method q̅_{0_0} may include additional acts not shown and/or may omit some shown acts, and the scope of the present disclosure is not limited in this regard.

At block q̅_{1_0}, the terminal device 130 determines link qualities of RSs in first and second sets of RSs for link failure detection received from the network device 110. In some embodiments, the first set of RSs is associated with a first CORESET (for example, C1), and the second set of RSs is associated with a second CORESET (for example, C2). In some embodiments, each RS in the first set of RSs may be configured with a first value of CORESETPoolIndex, and each RS in the second set of RSs may be configured with a second value of CORESETPoolIndex. In some embodiments, the first CORESET is associated with a first TRP (for example, TRP 120-1) of the network device 110, and the second CORESET is associated with a second TRP (for example, TRP 120-2) of the network device 110. In these embodiments, the first and second set of RSs are BFD RSs. In this way, the terminal device 130 may perform BFD per TRP.

In some embodiments, the terminal device 130 may receive information about the first and second sets (for example, q̅_{0_0} and q̅_{0_1}) from the network device 110. For example, the information may be RS resource configuration index. Of course, any other suitable forms are also feasible. In some embodiments, the terminal device 130 may receive the information by a higher layer parameter such as failureDectionResource. The terminal device 130 may determine, based on the information, the first and second sets of RSs from RSs received from the network device 110.

In some embodiments, the terminal device 130 may receive, from the network device 110, information about a plurality of RSs for link failure detection, determine a first part in the plurality of RSs as the first set, the first part being associated with the first CORESET, and determine a second part in the plurality of RSs as the second set, the second part being associated with the second CORESET. In some embodiments, the first part may be configured with a first value of a parameter associated with the first CORESET and the second part may be configured with a second value of the parameter associated with the second CORESET.

In some embodiments, a RS in the first set may be different from a RS in the second set. In some embodiments, a RS in the first set may be not QCLed (e.g., QCL type D) with a RS in the second set.

In some embodiments, the terminal device 130 may determine the first set based on a configuration parameter for the first CORESET; and determine the second set based on a configuration parameter for the second CORESET. In some embodiments, the configuration parameter may be a TCI state. Of course, any other suitable parameters are also feasible.

In some embodiments, the terminal device 130 may determine a plurality of RSs based on configuration parameters for the first and second CORESETs, determine a first part associated with the first CORESET in the plurality of RSs as the first set; and determine a second part associated with the second CORESET in the plurality of RSs as the second set. In some embodiments, the configuration parameters may be a TCI state. Of course, any other suitable parameters are also feasible.

In some embodiments, the terminal device 130 may receive information about the first set from the network device 110, and determine, based on the information, the first set from RSs received from the network device 110. In these embodiments, the terminal device 130 may determine the second set from the received RSs based on a configuration parameter for the second CORESET. In some embodiments, the configuration parameter may be a TCI state. Of course, any other suitable parameters are also feasible.

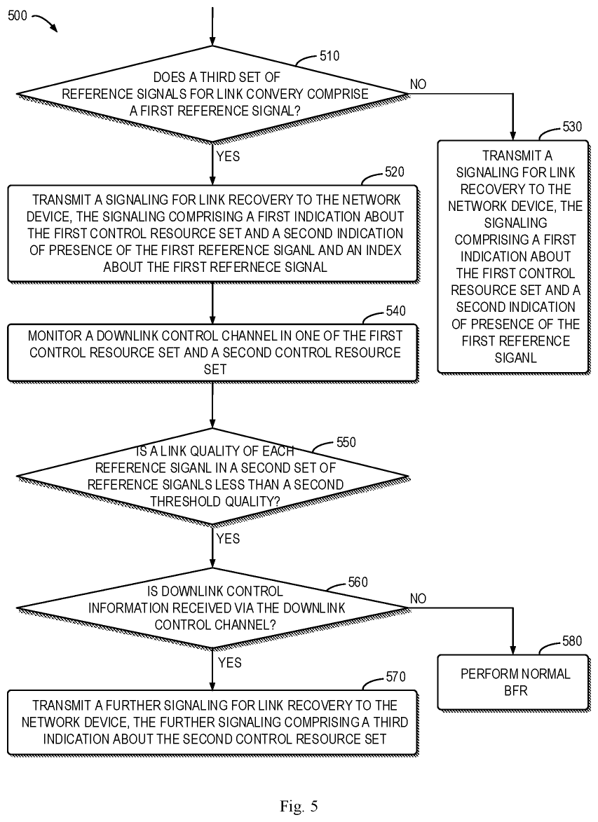

At block 420, the terminal device 130 may determine whether a link quality of each RS in the first set is less than the first threshold quality (for example, Q_{out,LR}). If determining that the link quality of each RS in the first set is less than the first threshold quality, that is, a link failure occurs in the first TRP, the process proceeds to block 430. At block 430, the terminal device 130 may transmit a signaling for link recovery to the network device 110, the signaling comprising a first indication about the first CORESET. Thereby, the link failure of the first TRP is informed to the network side and a link recovery procedure can be triggered per TRP. More detailed description will be given in connection with FIG. 5.

FIG. 5 illustrates a flowchart of another example method 500 for BFR implemented at a terminal device in accordance with some embodiments of the present disclosure. The method 500 can be implemented at the terminal device 130 shown in FIG. 1. For the purpose of discussion, the method 500 will be described with reference to FIG. 1. It is to be understood that the method 500 may include additional acts not shown and/or may omit some shown acts, and the scope of the present disclosure is not limited in this regard. In this embodiment, a link failure occurs for the first CORESET (for example, the first TRP).

As shown in FIG. 5, at block 510, the terminal device 130 may determine whether a third set of RSs (for example, q̅_{1_0}) for the link recovery comprise a first RS (for example, q_{new_1}) whose receiving power is larger than or equal to a first threshold power (for example, Q_{in,LR}). Thereby, a new candidate beam can be identified.

In some embodiments, the terminal device 130 may receive, from the network device 110, information about a plurality of RSs for link recovery, determine a first part associated with the first CORESET in the plurality of RSs as the third set, and determine a second part associated with the second CORESET in the plurality of RSs as a fourth set of RSs (for example, q̅_{1_1}) for link recovery. In some embodiments, the first part may be configured with a first value of a parameter, and the second part may be configured with a second value of the parameter.

In some embodiments, the terminal device 130 may receive information about the third and fourth sets from the network device 110, and determine, based on the received information, the third and fourth sets from RSs received from the network device 110. In some embodiments, the terminal device 130 may receive the information by a higher layer parameter such as candidateBeamRSList or candidateBeamRSListExt-r16 or candidateBeamRSList-r16 for radio link quality measurements. Of course, this is merely an example, any other suitable ways are also feasible.

In some embodiments, a RS in the third set may be different from a RS in the fourth set. In some embodiments, a RS in the third set may be not QCLed (e.g., QCL type D) with a RS in the fourth set.

If determining at block 510 that the third set comprises the first RS, the process proceeds to block 520. At block 520, the terminal device 130 may transmit a signaling for link recovery comprising a first indication about the first CORESET, a second indication about presence of the first RS, and an index about the first RS. In some embodiments, the information about the first RS may be index(es) for a periodic CSI-RS configuration. In some embodiments, the information about the first RS may be index(es) for a SS/PBCH block.

If determining at block 510 that the third set does not comprise the first RS, at block 530, the terminal device 130 may transmit, in the signaling for link recovery, the first indication about the first CORESET and the second indication about presence of the first RS.

At block 540, the terminal device 130 may monitor, in one of the first and second CORESETs, a downlink control channel from the network device 110, for link recovery of the first CORESET. In some embodiments, the terminal device 130 may monitor the downlink control channel in the first CORESET. For example, the terminal device 130 may monitor the downlink control channel in the first CORESET using the same antenna port quasi co-location parameters as that associated with the first RS.

In some alternative embodiments, the terminal device 130 may monitor the downlink control channel in the second CORESET. For example, the terminal device 130 may monitor the downlink control channel in the second CORESET using the antenna port quasi co-location parameters configured or updated for the second CORESET. For example, the downlink control channel may be used to update TCI state or QCL parameters for the first CORESET.

At block 550, the terminal device 130 may determine whether a link quality of each RS in the second set is less than a second threshold quality (for example, Q_{out,LR_1}). If determining that the link quality of each RS in the second set is less than a second threshold quality, that is, a link failure also occurs in the second TRP, the process may proceed to block 560.

At block 560, the terminal device 130 may determine whether downlink control information is received via the downlink control channel for the first TRP. In some embodiments, the terminal device 130 may determine whether downlink control information is received within a timing. For example, the timing may be predetermined or reported/determined as capability of the terminal device 130 or configured via at least one of RRC, MAC CE and DCI. Of course, this is merely an example, and any other suitable ways are also feasible. If determining that the downlink control information is received, the process proceeds to block 570.

At block 570, the terminal device 130 may transmit a further signaling for link recovery to the network device 110, the further signaling comprising a third indication about the second CORESET. In this way, a separate BFR also is applied to the second TRP.

In some embodiments, the terminal device 130 may determine whether the fourth set of RSs for link recovery comprise a second RS (for example, q_{new_2}) whose receiving power is larger than or equal to a second threshold power (for example, Q_{in,LR_1}). If determining that the fourth set comprises the second RS, the terminal device 130 may transmit, in the further signaling for link recovery, the third indication about the second CORESET, a fourth indication about presence of the second RS, and information about the second RS. If determining that the fourth set does not comprise the second RS, transmitting, in the signaling for link recovery, the third indication and the fourth indication about presence of the second RS. In some embodiments, the terminal device 130 may monitor, in one of the first and second CORESETs, a downlink control channel from the network device 110, for link recovery of the second CORESET.

If determining at block 560 that the downlink control information is not received successfully, the process proceeds to block 580 where the terminal device 130 may apply normal BFR for BWP/cell. In some embodiments, the terminal device 130 may determine whether all RSs in the sets q̅₀ and q̅_{0_1} fail and if all the RSs fail, determine new beam from the sets q̅_{1_0} and q̅_{1_1}.

In some embodiments, for a BWP/cell configured with first and second CORESETs, BFR may be applied in order of partial BFR and then normal BFR. In some embodiments, for Pcell and Pscell, if only one of the first and second sets failed, partial BFR may be applied, otherwise, PRACH will be applied for normal BFR. In some embodiments, for one Scell, if only one of the first and second sets failed, partial BFR may be applied, otherwise, normal BFR will be applied. In some embodiments, if a first uplink control channel with partial BFR and a second uplink control channel with normal BFR overlaps on one cell, the first uplink control channel may be dropped.

In some alternative embodiments, if determining that the link qualities of RSs in the first set are less than the first threshold quality and the link qualities of RSs in the second set are less than the second threshold quality, the terminal device 130 may transmit a further signaling for link recovery to the network device 110, the further signaling comprising a further indication about the first and second CORESETs.

In these embodiments, the terminal device 130 may determine whether the third set of RSs for the link recovery comprise the first RS whose receiving power is larger than or equal to the first threshold power, and determine whether the fourth set of RSs for the link recovery comprise the second RS whose receiving power is larger than or equal to the second threshold power. If determining that the third set comprises the first RS and the fourth set comprises the second RS, the terminal device 130 may transmit, in the further signaling, the further indication and information about at least one of the first and second RSs.

In some embodiments, the terminal device 130 may select one of the first and second RSs with a larger receiving power, and transmit information about the selected one of the first and second RSs in the further signaling. In some embodiments, the terminal device 130 may also transmit information about differential power of the other one of the first and second RSs with respect to the selected one. In some embodiments, the terminal device 130 may report, to the network device 110, the capability about whether partial BFR is supported.

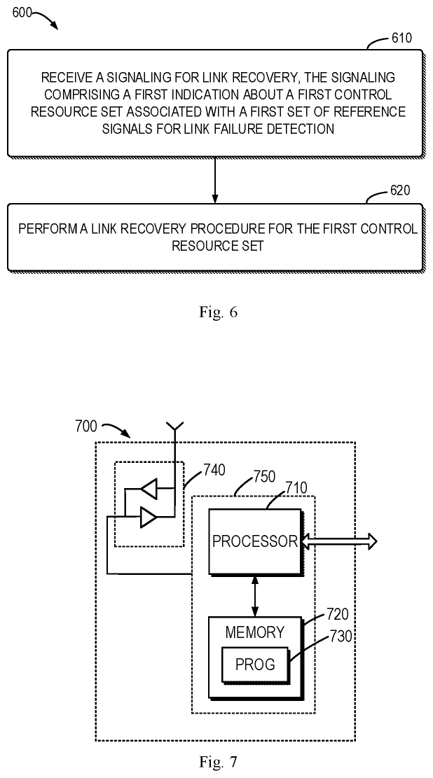

So far, the method implemented at a terminal device is described. Correspondingly, embodiments of the present disclosure also provide a method implemented at a network device. This will be described below with reference to FIG. 6.

FIG. 6 illustrates a flowchart of an example method 600 for BFR implemented at a network device in accordance with some embodiments of the present disclosure. The method 600 can be implemented at the network device 110 shown in FIG. 1. For the purpose of discussion, the method 600 will be described with reference to FIG. 1. It is to be understood that the method 600 may include additional acts not shown and/or may omit some shown acts, and the scope of the present disclosure is not limited in this regard.

As shown in FIG. 6, at block 610, the network device 110 receives a signaling for link recovery from the terminal device 130. The signaling comprises a first indication about a first CORESET (for example, C1) associated with a first set of RSs (for example, q̅_{0_0}). That is, the signaling is issued for the first TRP or for the set of CORESETs C1.

In some embodiments, the network device 110 may further receive, in the signaling, a second indication about presence of a first RS (for example, q_{new_1}) The first RS is determined from a third set of RSs (for example, q̅_{1_0}) for link recovery associated with the first CORESET.

At block 620, the network device 110 performs a link recovery procedure for the first CORESET (i.e., for the first TRP). In some embodiments, the network device 110 may transmit downlink control information associated with the first RS for link recovery.

In some embodiments, the network device 110 may transmit information about the first set of RSs and a second set of RSs (for example, q̅_{0_1}) for link failure detection to the terminal device 130, the second set being associated with a second CORESET (for example, C2). In some embodiments, a RS in the first set is different from a RS in the second set. In some embodiments, a RS in the first set may be not QCLed (e.g., QCL type D) with a RS in the second set.

In some embodiments, the network device 110 may transmit information about a set of RSs for link failure detection to the terminal device 130. In some embodiments, the network device 110 may transmit information about the first set to the terminal device 130.

In some embodiments, the network device 110 may transmit information about the third set of RSs and a fourth set of RSs ((for example, q̅_{1_1})) for link recovery to the terminal device 130, the fourth set being associated with the second CORESET. In some embodiments, the network device 110 may transmit information about a set of RSs for link recovery to the terminal device 130. In some embodiments, the network device 110 may transmit information about the third set to the terminal device 130.

In some embodiments, the network device 110 may further receive a further signaling for link recovery from the terminal device 130, the further signaling comprising a further indication about the first and second CORESETs. In some embodiments, the network device 110 may receive, in the further signaling, information about at least one of a first RS (for example, q_{new_1}) and a second RS (for example, q_{new_2}) The first RS is determined from the third set and the second RS is determined from the fourth set. In these embodiments, the network device 110 may transmit downlink control information associated with the at least one of the first and second RSs. In some embodiments, a RS in the third set may be different from a RS in the fourth set. In some embodiments, a RS in the third set may be not QCLed (e.g., QCL type D) with a RS in the fourth set.

In some embodiments, the first COREST is associated with a first TRP of the network device 130, and the second COREST is associated with a second TRP of the network device 130.

It can be seen that, embodiments of the present disclosure provide a solution for BFR per TRP. Embodiments of the present disclosure enable faster BFR than the traditional beam recovery schemes.

FIG. 7 is a simplified block diagram of a device 700 that is suitable for implementing embodiments of the present disclosure. The device 700 can be considered as a further example implementation of the network device 110 or the terminal device 130 as shown in FIG. 1. Accordingly, the device 700 can be implemented at or as at least a part of the network device 110 or the terminal device 130.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 730 is assumed to include program instructions that, when executed by the associated processor 710, enable the device 700 to operate in accordance with the embodiments of the present disclosure, as discussed herein with reference to FIGS. 3 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
determining, at a terminal device, link qualities of reference signals in first and second sets of reference signals for link failure detection received from a network device, the first set of reference signals being associated with a first control resource set and the second set of reference signals being associated with a second control resource set; and
in accordance with a determination that a link quality of each reference signal in the first set is less than the first threshold quality, transmitting a signaling for link recovery to the network device, the signaling comprising a first indication about the first control resource set.

2. The method of claim 1, wherein transmitting the signaling comprises:
determining whether a third set of reference signals for the link recovery comprise a first reference signal whose receiving power is larger than or equal to a first threshold power;
in accordance with a determination that the third set comprises the first reference signal, transmitting, in the signaling for link recovery, the first indication, a second indication about presence of the first reference signal, and an index about the first reference signal; and
in accordance with a determination that the third set does not comprise the first reference signal, transmitting, in the signaling for link recovery, the first indication and the second indication about presence of the first reference signal.

3. The method of claim 1, further comprising:
monitoring, in one of the first and second control resource sets, a downlink control channel from the network device for link recovery of the first control resource set.

4. The method of claim 3, further comprising:
in accordance with a determination that the link quality of each reference signal in the second set of reference signals is less than a second threshold quality and downlink control information is received via the downlink control channel, transmitting a further signaling for link recovery to the network device, the further signaling comprising a third indication about the second control resource set.

5. The method of claim 4, wherein transmitting the further signaling comprises:
determining whether a fourth set of reference signals for link recovery comprise a second reference signal whose receiving power is larger than or equal to a second threshold power, the fourth set of reference signals being associated with the second control resource set;
in accordance with a determination that the fourth set comprises the second reference signal, transmitting, in the further signaling for link recovery, the third indication, a fourth indication about presence of the second reference signal, and an index about the second reference signal; and
in accordance with a determination that the fourth set does not comprise the second reference signal, transmitting, in the signaling for link recovery, the third indication and the fourth indication about presence of the second reference signal.

6. The method of claim 1, further comprising:
in accordance with a determination that the link qualities of reference signals in the first set are less than the first threshold quality and the link qualities of reference signals in the second set are less than a second threshold quality, transmitting a further signaling for link recovery to the network device, the further signaling comprising a further indication about the first and second control resource sets.

7. The method of claim 6, wherein transmitting the further signaling comprises:
determining whether a third set of reference signals for the link recovery comprise a first reference signal whose receiving power is larger than or equal to a first threshold power;
determining whether a fourth set of reference signals for the link recovery comprise a second reference signal whose receiving power is larger than or equal to a second threshold power; and
in accordance with a determination that the third set comprises the first reference signal and the fourth set comprises the second reference signal, transmitting, in the further signaling, the further indication and an index about at least one of the first and second reference signals.

8. The method of claim 6, further comprising:
monitoring, in one of the first and second control resource sets, a downlink control channel from the network device for link recovery of the second control resource set.

9. The method of claim 1, further comprising:
receiving information about the first and second sets from the network device; and
determining, based on the information, the first and second sets of reference signals from reference signals received from the network device.

10. The method of claim 1, further comprising:
receiving, from the network device, information about a plurality of reference signals for link failure detection;
determining a first part in the plurality of reference signals as the first set, the first part being associated with the first control resource set; and
determining a second part in the plurality of reference signals as the second set, the second part being associated with the second control resource set.

11. The method of claim 1, further comprising:
determining the first set based on a configuration parameter for the first control resource set; and
determining the second set based on a configuration parameter for the second control resource set.

12. The method of claim 1, further comprising:
determining a plurality of reference signals based on configuration parameters for the first and second control resource sets;
determining a first part in the plurality of reference signals as the first set, the first part being associated with the first control resource set; and
determining a second part in the plurality of reference signals as the second set, the second part being associated with the second control resource set.

13. The method of claim 1, further comprising:
receiving information about the first set from the network device;
determining, based on the information, the first set from reference signals received from the network device; and
determining the second set from the received reference signals based on a configuration parameter for the second control resource set.

14. The method of claim 1, wherein a reference signal in the first set is different from a reference signal in the second set, or
wherein a reference signal in the first set is not quasi co-located with a reference signal in the second set.

15. The method of claim 2, further comprising:
receiving information about the third set from the network device, the third set being associated with the first control resource set; and
determining, based on the received information, the third set of reference signals from reference signals received from the network device.

16. The method of claim 2, further comprising:
receiving, from the network device, information about a plurality of reference signals for link recovery;
determining a first part in the plurality of reference signals as the third set, the first part being associated with the first control resource set; and
determining a second part in the plurality of reference signals as a fourth set of reference signals for link recovery, the second part being associated with the second control resource set.

17. The method of claim 2, wherein a reference signal in the third set of reference signals is different from or not quasi co-located with a reference signal in a fourth set of reference signals for link recovery associated with the second control resource set.

18. The method of claim 1, wherein the first control resource set is associated with a first transmission and reception point of the network device, and the second control resource set is associated with a second transmission and reception point of the network device.

19. A method of communication, comprising:
receiving, at a network device and from a terminal device, a signaling for link recovery, wherein the signaling comprising a first indication about a first control resource set associated with a first set of reference signals for link failure detection; and
performing a link recovery procedure for the first control resource set.

20. The method of claim 19, wherein the receiving further comprises:
receiving a second indication about presence of a first reference signal, the first reference signal being determined from a third set of reference signals for link recovery associated with the first control resource set; and
wherein the performing comprises:
transmitting downlink control information associated with first reference signal.

21. The method of claim 19, further comprising:
receiving a further signaling for link recovery from the terminal device, the further signaling comprising a further indication about the first and second control resource sets.

22. The method of claim 21, further comprising:
receiving, in the further signaling, information about at least one of a first reference signal and a second reference signal, the first reference signal being determined from a third set of reference signals for link recovery associated with the first control resource set, the second reference signal being determined from a fourth set of reference signals for link recovery associated with the second control resource set; and
wherein the performing comprises:
transmitting downlink control information associated with at least one of the first and second reference signals.

23. The method of claim 19, further comprising:
transmitting information about the first set of reference signals and a second set of reference signals for link failure detection to the terminal device, the second set being associated with a second control resource set.

24. The method of claim 19, further comprising:
transmitting information about a set of reference signals for link failure detection to the terminal device.

25. The method of claim 19, wherein a reference signal in the first set is different from a reference signal in a second set of reference signals, the second set being associated with a second control resource set, or
wherein a reference signal in the first set is not quasi co-located with a reference signal in the second set.

26. The method of claim 19, further comprising:
transmitting information about the first set to the terminal device.

27. The method of claim 20, further comprising:
transmitting information about the third set of reference signals and a fourth set of reference signals for link recovery to the terminal device, the third set being associated with the first control resource set and the fourth set being associated with a second control resource set.

28. The method of claim 20, further comprising:
transmitting information about a set of reference signals for link recovery to the terminal device.

29. The method of claim 20, further comprising:
transmitting information about the third set to the terminal device.

30. The method of claim 19, wherein the first control resource set is associated with a first transmission and reception point of the network device, and the second control resource set is associated with a second transmission and reception point of the network device.

31. A terminal device comprising:
a processor; and
a memory coupled to the processor and storing instructions thereon, the instructions, when executed by the processor, causing the terminal device to perform the method according to any of claims 1 to 18.

32. A network device comprising:
a processor; and
a memory coupled to the processor and storing instructions thereon, the instructions, when executed by the processor, causing the network device to perform the method according to any of claims 19 to 30.

33. A computer readable medium having instructions stored thereon, the instructions, when executed on at least one processor, causing the at least one processor to perform the method according to any of claims 1 to 18.

34. A computer readable medium having instructions stored thereon, the instructions, when executed on at least one processor, causing the at least one processor to perform the method according to any of claims 19 to 30.
